(19) United States
(12) Patent Application Publication
(10) Pub. No.: US 2011/0122642 A1
(43) Pub. Date: May 26, 2011

(54) HEADLAMP WITH A CARRYING ELEMENT PIVOTING IN A FIRST DIRECTION AND A LIGHT UNIT PIVOTING IN A SECOND DIRECTION

(75) Inventor: Thomas Herbers, Lippstadt (DE)

(73) Assignee: HELLA KGaA HUECK & CO., Lippstadt (DE)

(21) Appl. No.: 12/951,132

(22) Filed: Nov. 22, 2010

(30) Foreign Application Priority Data
Nov. 25, 2009 (EP) 09 177 015.06

(51) Int. Cl. F21V 19/02

(52) U.S. Cl. 362/524; 362/523

(57) ABSTRACT

Headlamp comprising a housing, a carrying element pivoting around a first axis in relation to the housing and a light unit pivoting around a second axis in relation to the carrying element, wherein the headlamp comprises a drive shaft for pivoting the light unit around the second axis such that a drive unit links the drive shaft to the light unit, wherein the drive shaft is suited and set up to transmit a rotary motion from an input drive head of the drive shaft to an output drive head of the drive shaft, wherein the input drive head is mounted on the housing, wherein the drive shaft comprises a first shaft section and a second shaft section, wherein first ends of the shaft sections, in order to transmit the rotary motion, can move in relation to one another in axial direction and interlink in a torque-proof manner, wherein a rotary motion to be transmitted is performed around a first axis of rotation in the first shaft section and a second axis of rotation in the second shaft section, and wherein the shaft sections are able to pivot around preferably multiple axes perpendicular to the first and second axes of rotation and in relation to one another.

### CROSS-REFERENCE TO RELATED APPLICATIONS

The present application claims priority to and incorporates herein by reference European Patent Application Serial No. 09 177 015.06 filed on Nov. 25, 2009

### BACKGROUND

The subject matter of the invention is a headlamp with a housing, a carrying element pivoting around a first axis with reference to the housing such that a first light unit may be attached to said carrying element, and a light unit pivoting around a second axis with reference to the carrying element, wherein the headlamp pivots the light unit around the second axis by means of a drive shaft linked to the light unit by a drive unit such that the drive shaft is suited and set up to transmit a rotary motion from a head on the input side of the drive shaft to a head on the output side of the drive shaft and such that the housing acts as the bearing of the head on the input side.

A headlamp of this design can be used as a main headlamp in a motor vehicle. The main headlamp of a motor vehicle is able to generate different light distributions to illuminate the road space in front of the motor vehicle. High beam and low beam are the most commonly known light distributions. The low beam in a vehicle's headlamp is set to illuminating an elongated strip below a horizontal line. A first light unit is responsible for producing this strip. Furthermore, an area shaped like a sector of a circle (the “sector”) is illuminated such that said sector—in vehicles for right-hand driving—is located towards the right of the center and above the horizontal line. Illumination of this sector area is provided by a second light unit in the headlamp.

In a headlamp of the aforementioned type, the first light unit is attached to a carrying element able to pivot inside the housing. This first light unit and the carrying element it is attached to can be pivoted around a first axis. A headlamp comprising a carrying element and a first light unit attached to it has been disclosed in German patent application DE 10 2007 040 728 A1. However, the headlamp thus disclosed does not comprise a second light unit.

The second light unit and the carrying element it is attached to are likewise able to pivot around the first axis in relation to the housing. However, it is also able to pivot around a second axis in relation to the carrying element. In order to set the low beam, the first and second light units are pivoted to produce the desired low beam distribution.

The low beam is set up when the headlamp has been installed in the vehicle. A first step of the setup procedure is to pivot the carrying element around the first-horizontal-axis in order to adjust the headlamp such that the strip illuminated by the first light unit is located below the horizontal line. At the same time, this sets the second light unit to project the sector area onto a location immediately above the horizontal line. However, after the setup process, the illuminated sector area could still be too far to the right or left. In order to remedy this problem, the second step is to pivot the second light unit around the second-vertical-axis in relation to the carrying element.

The drive shaft is the means of allowing the second light unit to pivot around the second-horizontal-axis in that a torque can be induced into the input drive head of said drive shaft and transferred to the output drive head and to the drive unit which then adjusts the second light unit. The input drive head of the drive shaft is mounted on the headlamp housing. A spanner flat located on the input drive head can be accessed from outside the housing. A tool for inducing the torque into the drive shaft can be placed on the spanner flat. However, pivoting the carrying element around the first axis offsets the output drive head of the drive shaft against the input drive head. In prior-art headlamps, this offset is compensated for by flexible shafts or cardan joints. The disadvantage of such solutions is that they are costly and time-consuming.

### SUMMARY

The present invention improves a headlamp of the aforementioned type such that an offset between the output drive head and the input drive head of the drive shaft can be compensated for by simple technical means.

A headlamp according to the invention has a drive shaft comprising a first shaft section and a second shaft section, wherein the first ends of the shaft sections, for the purpose of transmitting a rotary motion, interlink in the fashion of a splined joint such that they can move in axial direction in relation to one another and in a torque-proof manner, wherein a rotary motion to be transmitted revolves around a first axis of rotation in the first shaft section and a second axis of rotation in the second shaft section, and wherein the shaft sections can preferably pivot in relation to one another and around multiple axes perpendicular to the first and second axes of rotation.

Splined joints are deployed in splined shafts to transmit torques while allowing the input drive head of the drive shaft to move in axial direction against the drive shaft's output drive head. One publication describing this type of splined shaft is publication number DE 30 02 143 C2. Prior-art splined shafts, however, disallow the shaft sections making up the splined shaft to pivot around one or several axes perpendicular to the axes of rotation of shaft sections. This marks a difference between the drive shaft of an apparatus according to the invention and a prior-art splined shaft. The drive shaft of a headlamp according to the invention is thus designed such that the shaft sections can tilt towards one another. Thus, the drive shaft has at least one degree of freedom more than a standard splined shaft. The drive shaft of an apparatus according to the invention is therefore bendable. This bending movement allows the output drive head of the drive shaft to pivot vertically in relation to the input drive head by pivoting the carrying element around the first axis.

Since a headlamp according to the invention does not necessarily have to comprise a first light unit, the light unit may be the same as the second light unit referred to above.

A headlamp according to the invention may join the first shaft section to the second shaft section by an external gear, a hexagon head or similar means at the first end of the first shaft section. If this is so, the second shaft section joins to the first shaft section by a complementary internal gear, hexagon socket or similar means at its first end. By interlinking the complementary parts, the shaft sections are able to transmit torques from one shaft section to the other while being able to offset against one another in axial direction. As a matter of course, it is a feasible option to have the first end of the second shaft section feature a link element, which may be an external gear, a hexagon head or similar means and to have the first shaft section feature a complementary internal gear, hexagon socket or similar means.

The first shaft section may have the input drive head of the drive shaft at the end opposing the first end, and the second shaft section may have the drive output shaft at the end opposing the first end. It is also conceivable to have the first shaft section have the output drive head of the drive shaft at the end opposing the first end, and to have the second shaft section have the drive input shaft at the end opposing the first end.

In order to support the relative pivoting of the shaft sections around one of the axes perpendicular to the first and second axes of rotation, the external gear, hexagon head or similar means may be chamfered. This would allow the internal gear, hexagon socket or similar means to tangentially contact the external gear, hexagon head or similar means at varying relative positions of the shaft sections.

The input drive head of a headlamp according to the invention may comprise a hexagon socket to serve as a spanner flat.

In a headlamp according to the invention, the second shaft section may be mounted to the light unit such that it can pivot around the second axis of rotation.

The output drive head may comprise a bevel gear. The bevel gear of the drive output head may cog a bevel gear of the drive unit.

Further features and advantages of the present invention, as well as the structure and operation of various embodiments of the present invention, are described in detail below with reference to the accompanying drawings.

### BRIEF DESCRIPTION OF THE DRAWINGS

The figures attached hereto are taken to further explain the invention. The following is shown:

FIG. 1 is a first perspective view of a part of a headlamp according to the invention showing a drive shaft and a drive unit;

FIG. 2 is a second perspective view of the part of the headlamp shown in FIG. 1;

FIG. 3 is a section across the headlamp according to the invention including a section across the drive shaft and the drive unit;

FIG. 4 is a detail of FIG. 3, i.e., a sectional view of the input drive head;

FIG. 5 is a sectional view of a joint of a first shaft section and a second shaft section of the drive shaft;

FIG. 6 is a section across the headlamp according to the invention, including a section across the drive shaft and the drive unit showing the shaft sections of the drive shaft at a first relative angular opposition;

FIG. 7 is a section across the headlamp according to the invention, including a section across the drive shaft and the drive unit showing the shaft sections of the drive shaft at a second relative angular opposition;

FIG. 8 is a section across the headlamp according to the invention, including a section across the drive shaft and the drive unit showing the shaft sections of the drive shaft at a third relative angular opposition.

### DETAILED DESCRIPTION OF THE DRAWINGS

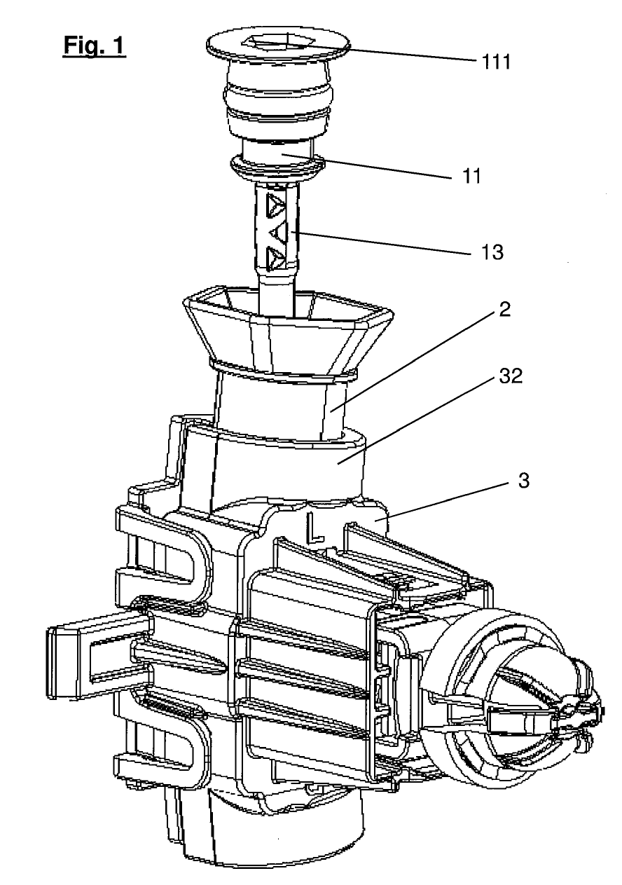

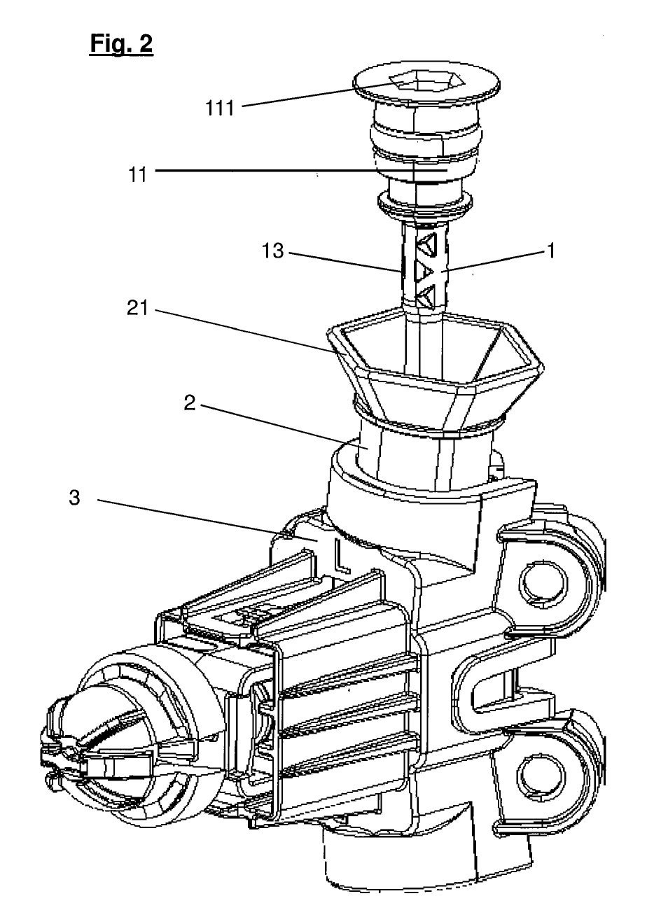

The part of the headlamp according to the invention shown from different angles in FIGS. 1 and 2 comprises the drive shaft 1, 2 and a drive unit 3 that can be driven by the drive shaft.

The drive shaft 1, 2 has two shaft sections, i.e., the first shaft section 1 and the second shaft section 2. Whereas the two shaft sections 1, 2 interlink in the fashion of a splined joint, they do not make up a splined shaft in the narrower sense of the word. As opposed to a splined shaft in the narrower sense of the word, the shaft sections are not only able to move in axial direction and in relation to one another and also designed to transmit torques. Shaft sections 1, 2 are also able to pivot in relation to one another. This is not the case in a splined shaft in the narrower sense of the word.

The first shaft section comprises an input drive head 11 that can be used to induce a torque into the drive shaft 1, 2. For this purpose, input drive head 11 has a spanner flat in the shape of a hexagon socket 111. The input drive head 11 is mounted inside a part 41 of a housing 4 such that the first shaft section 1 can perform a tumbling movement. The part 41 that the input drive head 11 is mounted inside housing 4 is made up by a fork 41 that engages in a groove 113 in the input drive head 11. The fork 41 has enough clearance in the groove 113 to support the tumbling movement of the first shaft section 1 in relation to the housing 4. There are conical sections 114, 115 in the input drive head 11 that also support a tumbling movement of the input drive head 11 in relation to a hollow cylinder 42 that is part of the housing 4. There is a groove between said conical sections 114, 115 that an O-ring 112 is place in. The O-ring 112 seals the inside of the housing 4 against the outside of the housing. This is important to prevent moisture, e.g. from an engine compartment, from penetrating the headlamp. The axes that the input drive head 11 may pivot around in relation to the housing 4 are located in the o-ring plane 112.

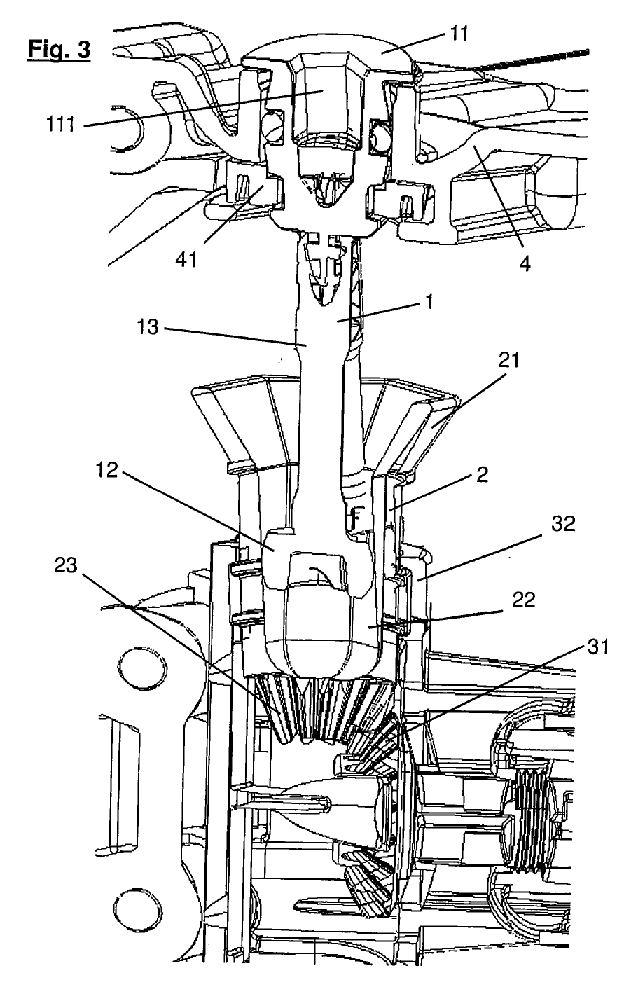

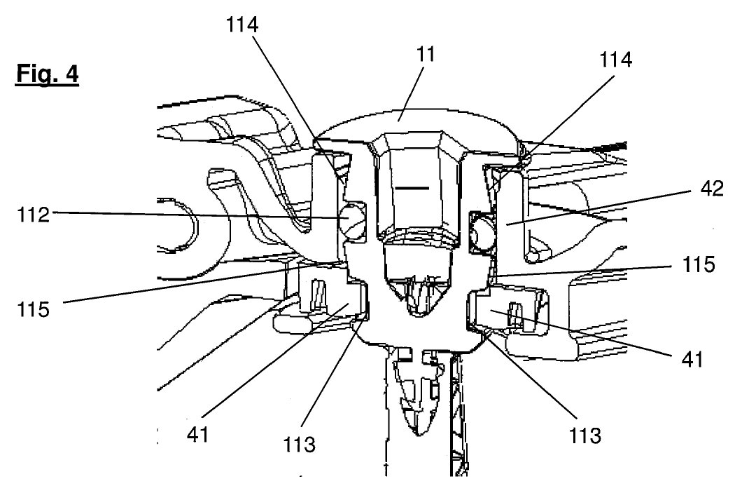

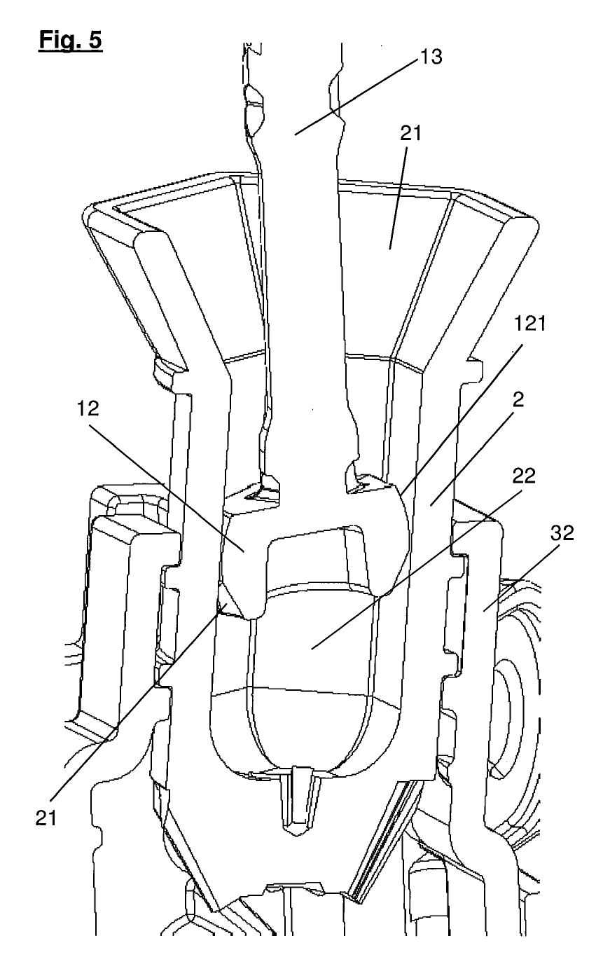

The input drive head 11 is extended by a shank that terminates at the first end of the shaft. There is a hexagon head 12 at the first end of the shaft (see FIGS. 3 to 6). The hexagon head 12 is arched or convex and plunges into an elongated hexagon socket 22 of the second shaft section 2. The second shaft section is mounted to a bearing section 31 of the drive unit such that it can pivot around its long axis. As opposed to the first shaft section 1, the second shaft section 2 is very short. It comprises an output drive head 23 with a bevel gear that interacts with a bevel gear 32 of the drive unit 3 to transmit a rotary motion of the drive shaft 1, 2 to the bevel gear 32 of the drive unit 3. Without any transition, the first end of the second shaft section 2 protrudes from the output drive head 23 of the second shaft section. This second end of the shaft is where the elongated hexagon socket 22 is located. The convex hexagon head 12 at the first end of the first shaft section 1 plunges into the hexagon socket 22. The hexagon head 12 is able to move inside the hexagon socket 22 in axial direction. Moreover, the hexagon head 12 and the shank 13 joined to it, i.e. the entire first shaft section 1, is able to pivot in relation to the hexagon socket 22 or the entire second shaft section 2 such that the long axes of the first shaft section 1 and the second shaft section 2, which are equivalent to the axes of rotation of shaft sections 1, 2, tilt towards one another. A funnel 21 in the opening of the hexagon socket 22 helps to guide the first shaft section 1 as the drive shaft 1, 2 is installed in the headlamp.

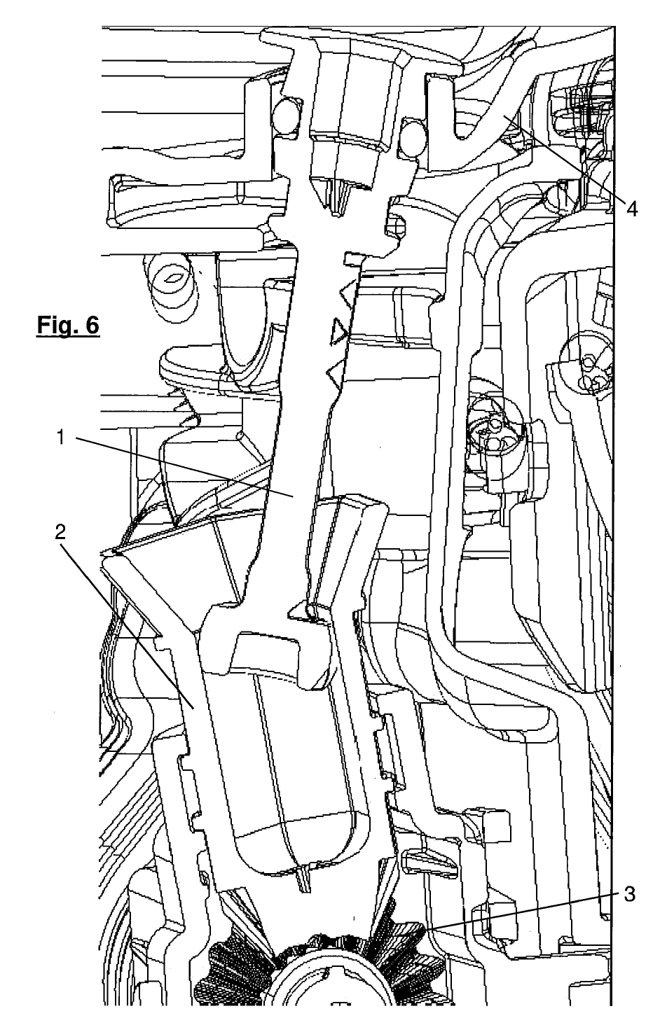

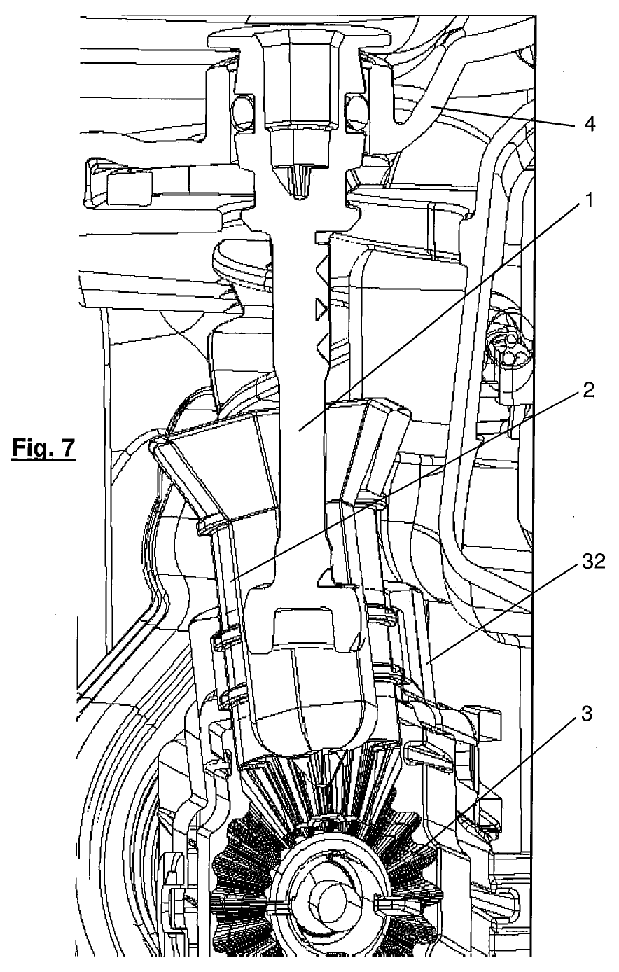

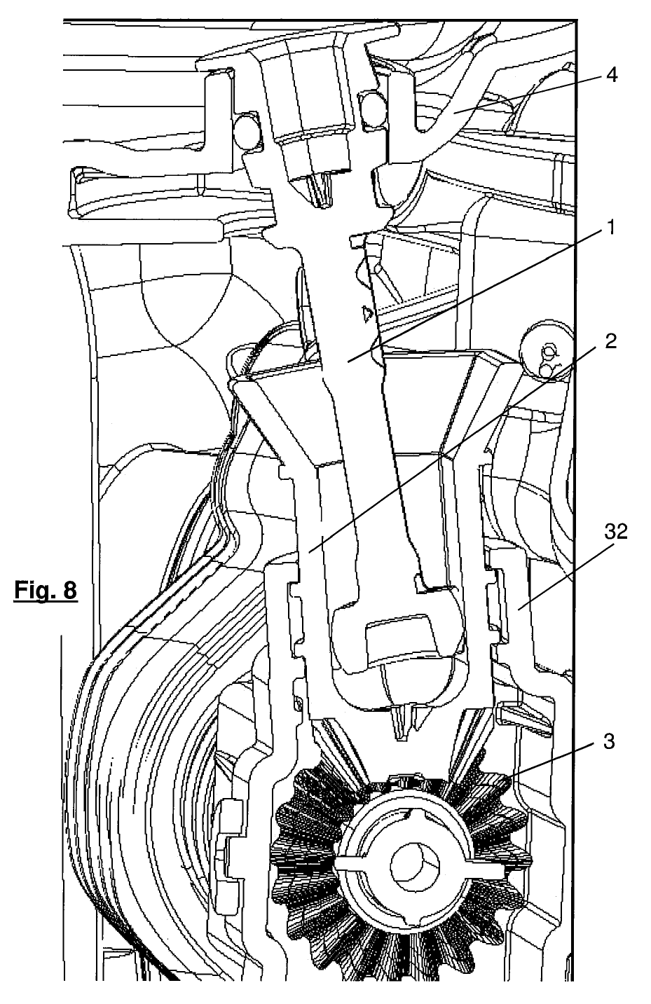

FIGS. 6 to 8 show different angular positions or tilt angles of the first shaft section 1 in relation to the second shaft section 2. The different angles are provoked by pivoting the headlamp's carrying element. The different positions of the light unit are illustrated by the different positions of the second shaft section 2 and/or the drive unit 3. The drive unit 3 fastened to the (second) light unit to be adjusted.

In view of the foregoing, it will be seen that several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

### REFERENCE ITEMS

1 first shaft section
11 input drive head
111 hexagon socket
112 O-ring
113 groove
114 taper
115 taper
12 hexagon head, first end
13 shank
2 second shaft section
21 funnel
22 hexagon socket, first end
23 output drive head, bevel gear
3 drive unit
31 bevel gear
32 bearing section
4 housing
41 fork

I claim:

1. A headlamp with a housing comprising:
a carrying element pivoting around a first axis with reference to the housing;
a light unit pivoting around a second axis with reference to the carrying element;
wherein the headlamp pivots the light unit around the second axis with a drive shaft linked to the light unit by a drive unit such that the drive shaft transmits a rotary motion from a head on the input side of the drive shaft a head on the output side of the drive shaft;
such that the housing acts as the bearing of the head on the input side;
the drive shaft comprising a first shaft section and a second shaft section;
the first ends of the shaft sections transmitting a rotary motion;
a multi-key joint interlink between said sections moveable in axial direction in relation to one another and in a torque-proof manner;
a rotary motion to be transmitted revolving around a first axis of rotation in the first shaft section and around a second axis of rotation in the second shaft section;
wherein the shaft sections pivot in relation to one another around multiple axes substantially perpendicular to at least one of the first axis of rotation and the second axis of rotation.

2. The headlamp of claim 1 further comprising a link element linking the first shaft section to the second shaft section.

3. The headlamp of claim 1, further comprising the first shaft section links to the second shaft section by an external gear, a hexagon head at a first shaft first end, and the second shaft section links to the first shaft section by a complementary internal gear, a hexagon socket at a second shaft first end.

4. The headlamp of claim 1, further comprising the first shaft section having a drive input head of the drive shaft at an end opposite a first end, and the second shaft section having the drive output head at a second shaft end opposite the first end.

5. The headlamp of claim 2, further comprising the link element supporting a pivoting of one of the axes perpendicular to the first axis of rotation and the second axis of rotation, and is chamfered or convex such that the link or element is tangential in varying referential positions of the shaft sections.

6. The headlamp of claim 1, further comprising the drive input head has a hexagon socket.

7. The headlamp of claim 1, further comprising in that the second shaft section is attached to the light unit such that said second shaft section can pivot around the second axis of rotation.

8. The headlamp of claim 1, further comprising the drive output head comprises a bevel gear.

9. The headlamp of claim 7, further comprising the bevel gear of the drive output head cogs a bevel gear of the drive unit.

10. The headlamp of claim 1, further comprising the drive input head comprises a retainer for a sealing ring, and that the sealing ring seals the drive input head against the housing.

11. The headlamp of claim 9 wherein the retainer is an O-ring.
